(19) United States
(12) Patent Application Publication
(10) Pub. No.: US 2024/0091717 A1
(43) Pub. Date: Mar. 21, 2024

(54) GAS SEPARATION MEMBRANE AND METHOD OF PRODUCING GAS SEPARATION MEMBRANE

(71) Applicant: SEIKO EPSON CORPORATION, TOKYO (JP)

(72) Inventors: Taisuke NAKASHIMA, CHINO-SHI (JP); Yasutaka MATSUMOTO, Suwa-shi (JP)

(21) Appl. No.: 18/467,133

(22) Filed: Sep. 14, 2023

(30) Foreign Application Priority Data
Sep. 15, 2022 (JP) 2022-147379

(51) Int. Cl. B01D 69/12; B01D 53/22; B01D 69/02; B01D 71/70

(52) U.S. Cl. CPC B01D 69/1214; B01D 53/228; B01D 69/02; B01D 69/1213; B01D 69/1216; B01D 69/1218; B01D 69/127; B01D 71/70; B01D 2257/504; B01D 2325/02; B01D 2325/04

(57) ABSTRACT

A gas separation membrane includes a porous layer, a first resin layer provided at a surface on one side of the porous layer, the first resin layer including an organopolysiloxane, and a second resin layer provided at a surface of the first resin layer on a side opposite to that of the porous layer, the second resin layer including an organopolysiloxane. The first resin layer has a porosity greater than that of the second resin layer. The second resin layer is chemically bonded to the first resin layer.

The present application is based on, and claims priority from JP Application Serial Number 2022-147379, filed Sep. 15, 2022, the disclosure of which is hereby incorporated by reference herein in its entirety.

### BACKGROUND

### 1. Technical Field

The present disclosure relates to a gas separation membrane and a method of producing a gas separation membrane.

### 2. Related Art

Techniques that capture and directly recover carbon dioxide from the atmosphere are being studied towards the goal of carbon neutral. Known techniques of this kind include chemical absorption methods in which carbon dioxide is absorbed by an absorption liquid or an adsorption material, as well as membrane separation methods in which carbon dioxide is separated using a gas separation membrane.

For example, JP-A-60-75320 discloses a gas-selective permeable membrane which selectively allows the passage of a specific gas. The gas-selective permeable membrane is produced by a process including stacking a thin film of a siloxane compound on a film-like polymeric porous support, subjecting the surface layer of the thin film to a plasma treatment using a non-polymerizable gas, and depositing a plasma-polymerized film on the thin film. JP-A-60-75320 also discloses that this process yields a gas-selective permeable membrane having strong adhesion between the thin film and the plasma-polymerized film, and that the thickness of the thin film is from 1 μm to 30 μm. Further, JP-A-60-75320 discloses that a gas such as oxygen, hydrogen, helium, or the like is selectively passed through the gas-selective permeable membrane, and the separated gas is recovered. It is believed that carbon dioxide can be separated by using such a gas-selective permeable membrane.

However, the gas-selective permeable membrane described in JP-A-60-75320 includes a composite membrane in which a plasma-polymerized film is deposited on a thin film. Such a composite membrane has insufficient adhesion between the films. For this reason, peeling or the like occurs easily between the films, and the function of the gas-selective permeable membrane deteriorates easily. Further, regarding the gas-selective permeable membrane described in JP-A-60-75320, when the thin film is being formed at the porous support, the pores of the porous support need to be sealed by the thin film. This requires the thin film to have a sufficient thickness. However, when the thickness of the thin film increases, the amount of gas passed through decreases, and a large amount of energy is required for gas separation.

The situation above presents the challenge of realizing a gas separation membrane having high mechanical strength and high transmission rate with respect to the target gas.

### SUMMARY

A gas separation membrane according to an application example of the present disclosure includes: a porous layer, a first resin layer provided at a surface on one side of the porous layer, the first resin layer including an organopolysiloxane, and a second resin layer provided at a surface of the first resin layer on a side opposite to that of the porous layer, the second resin layer including an organopolysiloxane, wherein the first resin layer has a porosity greater than that of the second resin layer, and the second resin layer is chemically bonded to the first resin layer.

A method of producing a gas separation membrane according to an application example of the present disclosure includes: a first resin layer forming step of forming a film of an organopolysiloxane at a surface on one side of a porous layer to form a first resin layer, a second resin layer forming step of forming a film of an organopolysiloxane at a surface on one side of a sacrificial layer to form a second resin layer, a joining step of bringing the first resin layer and the second resin layer into contact with each other and subjecting the first resin layer and the second resin layer to pressure-joining, and a sacrificial layer removing step of removing the sacrificial layer.

### BRIEF DESCRIPTION OF THE DRAWINGS

FIG. 1 is a cross-sectional view schematically illustrating a gas separation membrane according to an embodiment.

FIG. 2 is a flowchart explaining a method of producing the gas separation membrane according to an embodiment.

FIG. 3 is a cross-sectional view schematically explaining a production method of producing the gas separation membrane illustrated in FIG. 2.

FIG. 4 is a cross-sectional view schematically explaining the production method of producing the gas separation membrane illustrated in FIG. 2.

FIG. 5 is a cross-sectional view schematically explaining the production method of producing the gas separation membrane illustrated in FIG. 2.

FIG. 6 is a cross-sectional view schematically explaining the production method of producing the gas separation membrane illustrated in FIG. 2.

FIG. 7 is a cross-sectional view schematically explaining the production method of producing the gas separation membrane illustrated in FIG. 2.

FIG. 8 is an enlarged view of an area A in FIG. 7.

FIG. 9 are X-ray photoelectron spectroscopy spectra including a Si2p peak obtained for a surface and an inner portion of a composite layer illustrated in FIG. 8.

### DESCRIPTION OF EMBODIMENTS

A gas separation membrane and a method of producing a gas separation membrane according to an aspect of the present disclosure will be described in detail below with reference to an embodiment illustrated in the accompanying drawings.

1. Gas Separation Membrane

First, a configuration of the gas separation membrane according to an embodiment will be described.

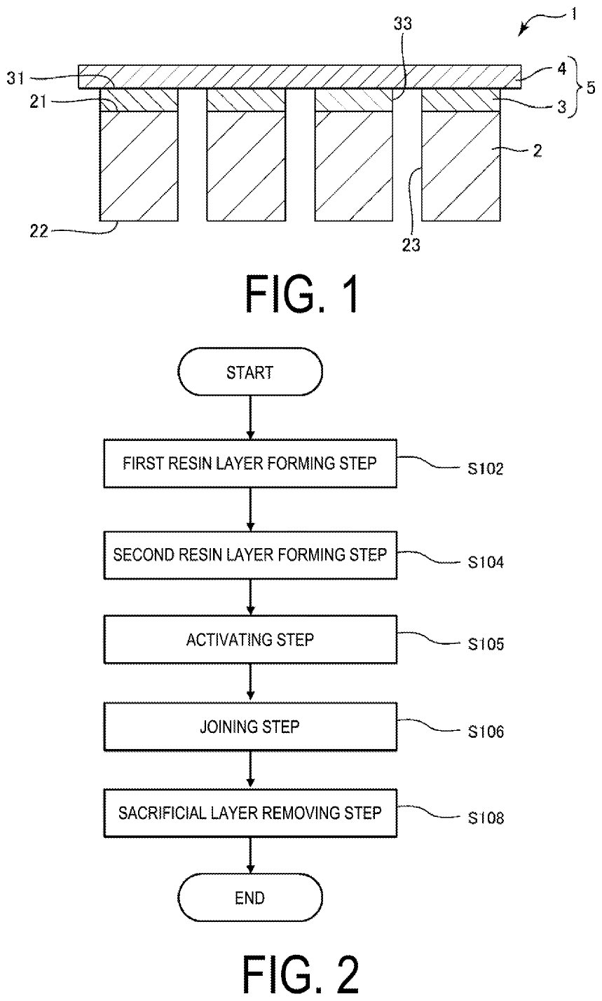

FIG. 1 is a cross-sectional view schematically illustrating a gas separation membrane 1 according to an embodiment.

The gas separation membrane 1 illustrated in FIG. 1 has the function of selectively allowing the passage of a specific gas component from a mixed gas containing a plurality of gas components. The gas separation membrane 1 illustrated in FIG. 1 includes a porous layer 2, a first resin layer 3, and a second resin layer 4.

The porous layer 2 is a porous substance including pores 23 illustrated in FIG. 1. The porous layer 2 includes a first surface 21 (surface on one side) and a second surface 22 (surface on the other side) which are in a front-and-back relationship to each other.

The first resin layer 3 is provided at the first surface 21 of the porous layer 2 and contains an organopolysiloxane. Organopolysiloxanes are polymers including repeating units of —Si—O— in the main chain and including organic groups in side chains. The first resin layer 3 includes a target joining surface 31. The target joining surface 31 is a surface of the first resin layer 3 on a side opposite to that of the porous layer 2.

The second resin layer 4 is provided at the target joining surface 31 of the first resin layer 3 and contains an organopolysiloxane. That is, the first resin layer 3 and the second resin layer 4 constitute a composite layer 5.

In the gas separation membrane 1 described above, the first resin layer 3 has a porosity greater than that of the second resin layer 4. Specifically, the first resin layer 3 includes pores 33 corresponding to the pores 23 contained in the porous layer 2. Meanwhile, the second resin layer 4 has a smaller ratio of the pores 33 than that of the first resin layer 3, and may be a dense layer as illustrated in FIG. 1. That is, the first resin layer 3 has a porosity greater than that of the second resin layer 4.

Further, the second resin layer 4 is chemically bonded to the first resin layer 3. The term “chemically bonded” means that the second resin layer 4 and the first resin layer 3 are bonded by chemical interactions such as hydrogen bonding or covalent bonding, rather than being in physical contact with each other or being deposited on each other.

In the gas separation membrane 1 described above, both the adhesion of the second resin layer 4 to the porous layer 2 and the gas permeability of the composite layer 5 are achieved. Specifically, since the second resin layer 4 is chemically bonded to the first resin layer 3, peeling or the like is suppressed even when the second resin layer 4 has a small thickness. That is, there is no need to consider increasing adhesion by increasing the thickness of the second resin layer 4, which allows the second resin layer 4 to have a sufficiently small film thickness. This makes it possible to sufficiently increase the gas permeability of the gas separation membrane 1.

Note that the posture of the gas separation membrane 1 during use is not limited. In the gas separation membrane 1 illustrated in FIG. 1, the mixed gas is supplied to the upper side of FIG. 1. Accordingly, in the following description, the upper side of the gas separation membrane 1 illustrated in FIG. 1 is referred to as “upstream”. In the gas separation membrane 1 illustrated in FIG. 1, a specific gas component passes through the gas separation membrane 1 from the upper side towards the lower side in FIG. 1. Accordingly, in the following description, the lower side of the gas separation membrane 1 illustrated in FIG. 1 is referred to as “downstream”.

1.1. Porous Layer

As described above, the porous layer 2 is a porous substance including the pores 23, and has good gas permeability. The porous layer 2 also has high rigidity and is supporting the second resin layer 4.

Examples of the constituent material of the porous layer 2 include a polymer material, a ceramic material, and a metal material. The constituent material of the porous layer 2 may also be a composite material of any of the aforementioned materials and another material.

Examples of the polymer material include: polyolefin resins, such as polyethylene and polypropylene; fluororesins, such as polytetrafluoroethylene, polyvinyl fluoride, and polyvinylidene fluoride; polystyrene; cellulose acetate; polyurethane; polyacrylonitrile; polyphenylene oxide; polysulfone; polyethersulfone; polyimide; and polyaramid.

Examples of the ceramic material include alumina, cordierite, mullite, silicon carbide, and zirconia. Examples of the metal material include stainless steel. The constituent material of the porous layer 2 may also be a composite material containing two or more of the aforementioned materials.

Among these examples, the constituent material of the porous layer 2 may be a ceramic material. Since ceramic materials are sintered materials, they contain individual or continuous pores. Therefore, by using a ceramic material as the constituent material of the porous layer 2, the adhesion between the porous layer 2 and the first resin layer 3 can be further improved.

In addition to the flat-sheet shape illustrated in FIG. 1, the shape of the porous layer 2 may be a spiral shape, a tubular shape, a hollow-fiber shape, or the like.

The average thickness of the porous layer 2, although not limited, may be from 1 μm to 3000 μm, may be from 5 μm to 500 μm, and may be from 10 μm to 150 μm. This gives the porous layer 2 necessary and sufficient rigidity to support the second resin layer 4.

Note that the average thickness of the porous layer 2 is an average value of thicknesses in the stacking direction measured at ten locations of the porous layer 2. The thickness measurement of the porous layer 2 can be carried out by using, for example, a thickness gauge.

The porous layer 2 includes the pores 23, and the average diameter of the pores 23 is referred to as the “average pore diameter”. The average pore diameter of the porous layer 2 may be 0.1 μm or less, may be from 0.01 μm to 0.09 μm, and may be from 0.01 μm to 0.07 μm. In this way, the first resin layer 3 and the second resin layer 4 are less likely to run over downstream of the porous layer 2.

Note that the average pore diameter of the porous layer 2 is measured by a through-pore diameter evaluation device. Examples of the through-pore diameter evaluation device include Perm-Porometer available from Porous Materials Inc.

The porosity of the porous layer 2 may be from 20% to 90%, and may be from 30% to 80%. This allows the porous layer 2 to have both good gas permeability and sufficient rigidity.

Note that the porosity of the porous layer 2 is measured by the above-described through-pore diameter evaluation device.

1.2. First Resin Layer

The first resin layer 3 is formed at the first surface 21 of the porous layer 2, that is, the surface upstream of the porous layer 2. As such, the first resin layer 3 inherits the porosity of the porous layer 2 and includes the pores 33. As a result, the first resin layer 3 functions as an intermediate layer interposed between the porous layer 2 and the second resin layer 4 while hardly sealing any pores 23 of the porous layer 2.

The constituent material of the first resin layer 3 is an organopolysiloxane. One molecule of the organopolysiloxane contains at least a unit represented by R¹SiO_{3/2} (T unit), a unit represented by R²R³SiO_{2/2} (D unit), and a unit represented by R⁴R⁵R⁶,Si_{1/2} (M unit) as basic constituent units. Note that in each unit, R¹ to R⁶ each represents an aliphatic hydrocarbon or a hydrogen atom. One molecule of the organopolysiloxane contains a combination of the T unit, the D unit, and the M unit.

Specific examples of the organopolysiloxane include polydimethylsiloxane, polymethylphenylsiloxane, polydiphenylsiloxane, polysulfone/polyhydroxystyrene/polydimethylsiloxane copolymer, dimethylsiloxane/methylvinylsiloxane copolymer, dimethylsiloxane/diphenylsiloxane/methylvinylsiloxane copolymer, methyl-3,3,3-trifluoropropylsiloxane/methylvinylsiloxane copolymer, dimethylsiloxane/methylphenylsiloxane/methylvinylsiloxane copolymer, vinyl-terminated diphenylsiloxane/dimethylsiloxane copolymer, vinyl-terminated polydimethylsiloxane, H-terminated polydimethylsiloxane, and dimethylsiloxane-methylhydrosiloxane copolymer. The constituent material of the first resin layer 3 may also be one of these examples or a composite of two or more of these examples. It should be noted that these examples include the forms in which a cross-linking reaction product is formed.

Note that organopolysiloxanes have good affinity particularly for carbon dioxide. This affinity contributes to higher selective separation properties with respect to a gas component targeted to be separated. As such, the first resin layer 3 exhibits particularly high selective separation properties with respect to carbon dioxide.

Note that the constituent material of the first resin layer 3 may contain an optional component at a ratio smaller than that of the organopolysiloxane in a range that does not impair the function of the first resin layer 3.

The average thickness of the first resin layer 3, although not limited, may be 1000 nm or less, may be from 10 nm to 500 nm, and may be from 30 nm to 300 nm. This allows the first resin layer 3 to function particularly favorably as an intermediate layer.

Note that the average thickness of the first resin layer 3 can be obtained, for example, by magnifying and observing a cross section of the gas separation membrane 1 and calculating the average value of the thicknesses at ten locations.

The average pore diameter of the first resin layer 3 tends to be associated with the average pore diameter of the porous layer 2. As such, the average pore diameter of the first resin layer 3 may be from 50% to 200%, and may be from 75% to 150%, of the average pore diameter of the porous layer 2. In this way, the second resin layer 4 is less likely to run over downstream of the first resin layer 3. This can, in turn, reduce the likelihood of problems such as sealing of the pores 33 of the first resin layer 3 and failure to ensure the thickness of the second resin layer 4.

Note that the average pore diameter of the first resin layer 3 can be obtained, for example, by magnifying and observing a cross section of the gas separation membrane 1 and calculating the average value of diameters of ten pores 33.

The porosity of the first resin layer 3 tends to be associated with the porosity of the porous layer 2. As such, the porosity of the first resin layer 3 may be from 50% to 200%, and may be from 75% to 150%, of the porosity of the porous layer 2. As a result, the first resin layer 3 functions as an intermediate layer interposed between the porous layer 2 and the second resin layer 4 without significantly inhibiting the gas permeability of the porous layer 2.

The porosity of the first resin layer 3 is greater than the porosity of the second resin layer 4. As will be described later, the second resin layer 4 is a dense layer with a small number of pores. When the porosity of the first resin layer 3 is greater than that of the second resin layer 4, the first resin layer 3 functions as an intermediate layer interposed between the porous layer 2 and the second resin layer 4 without significantly inhibiting the gas permeability of the porous layer 2. In addition, with the difference in porosities, the rigidity of the first resin layer 3 can be made smaller than that of the second resin layer 4. Therefore, even when a difference in thermal expansions arises between the porous layer 2 and the second resin layer 4, the first resin layer 3 can mitigate the difference.

Note that the porosity of the first resin layer 3 can be obtained, for example, by magnifying and observing a cross section of the gas separation membrane 1 and calculating the area fraction of the pores 33 in the area of the observation range.

1.3. Second Resin Layer

The second resin layer 4 is formed at the target joining surface 31 of the first resin layer 3, that is, the surface upstream of the first resin layer 3. As described above, the second resin layer 4 is a dense layer, and thus it seals the pores 33 of the first resin layer 3. As a result, the second resin layer 4 has gas separation properties that separate upstream and downstream and selectively allow the passage of a specific gas component.

The constituent material of the second resin layer 4 is an organopolysiloxane. The organopolysiloxane may be one of the organopolysiloxanes described above. The constituent material of the second resin layer 4 may be the same as or different from the constituent material of the first resin layer 3.

Note that organopolysiloxanes have good affinity particularly for carbon dioxide. This affinity contributes to higher selective separation properties with respect to a gas component targeted to be separated. As such, the second resin layer 4 exhibits particularly high selective separation properties with respect to carbon dioxide.

Note that the constituent material of the second resin layer 4 may contain an optional component at a ratio smaller than that of the organopolysiloxane in a range that does not impair the function of the second resin layer 4.

The second resin layer 4 is chemically bonded to the first resin layer 3. As described above, examples of the chemical bonding include hydrogen bonding and covalent bonding, and the chemical bonding may be covalent bonding. This allows the second resin layer 4 to adhere more firmly to the porous layer 2 via the first resin layer 3. As a result, the gas separation membrane 1 has particularly good mechanical strength.

Such good mechanical strength allows for a degree of freedom in the form of the gas separation membrane 1 during use. For example, the gas separation membrane 1 may be used while bent or folded. When the gas separation membrane 1 is used in such a state, peeling may occur between the porous layer 2 and the second resin layer 4.

Meanwhile, when the second resin layer 4 and the first resin layer 3 constitute the composite layer 5 together, occurrence of peeling or the like is less likely. As a result, the gas separation membrane 1 is less likely to be damaged even when used while bent or folded. When the gas separation membrane 1 is in a folded state, for example, the surface area of the gas separation membrane 1 can be further increased without increasing the area of a module using the gas separation membrane 1. As such, the density of the module using the gas separation membrane 1 can be increased.

The average thickness of the second resin layer 4, although not limited, may be 1000 nm or less, may be from 10 nm to 800 nm, may be from 30 nm to 500 nm, and may be from 50 nm to 200 nm. This allows the second resin layer 4 to have sufficient gas permeability while ensuring the above-described gas separation properties. As a result, the selective separation properties with respect to a specific gas component is good, and the input amount of energy required for the separation can be reduced, in other words, the pressure difference between upstream and downstream of the gas separation membrane 1 can be reduced.

The sum of the average thickness of the first resin layer 3 and the average thickness of the second resin layer 4 may be 1500 nm or less, and may be from 50 nm to 500 nm. This allows the composite layer 5 to have both good adhesion to the porous layer 2 and good gas permeability. Note that, when the sum of the average thicknesses described above is less than the aforementioned lower limit value, the adhesion of the second resin layer 4 to the porous layer 2 may deteriorate depending on the thickness of the first resin layer 3. In addition, depending on the thickness of the second resin layer 4, the selective separation properties with respect to a specific gas component may decrease. Meanwhile, when the sum of the average thicknesses described above exceeds the upper limit value, the gas permeability may decrease.

The difference between the average thickness of the first resin layer 3 and the average thickness of the second resin layer 4 may be from 0 nm to 300 nm, and may be from 0 nm to 150 nm. This reduces the likelihood of peeling or the like due to an excessively large difference in film thicknesses. Note that, the difference is obtained by subtracting the average thickness of the first resin layer 3 from the average thickness of the second resin layer 4.

In addition to the above description of the gas separation membrane 1 according to an embodiment, an optional layer may be provided in at least one of the following three locations: downstream of the porous layer 2, between the porous layer 2 and the first resin layer 3, or upstream of the second resin layer 4. For example, an optional functional group may be introduced upstream of the second resin layer 4 by the use of a coupling agent or the like. Affinity to a gas component targeted to be separated can be imparted by selecting the functional group as appropriate.

2. Method of Producing Gas Separation Membrane

Next, a method of producing the gas separation membrane according to an embodiment will be described.

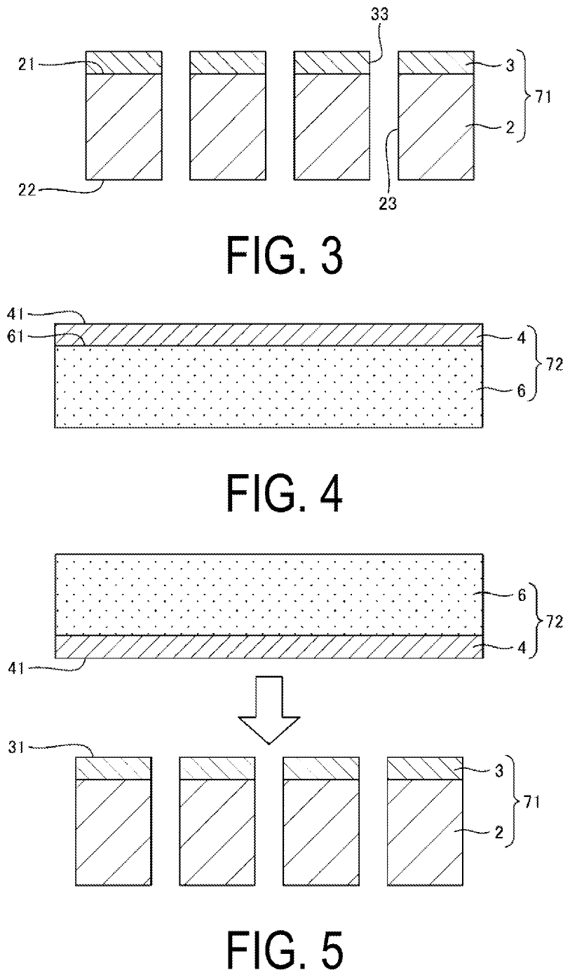

FIG. 2 is a flowchart explaining the method of producing the gas separation membrane according to an embodiment. FIG. 3 to FIG. 7 are cross-sectional views schematically explaining the production method of producing the gas separation membrane illustrated in FIG. 2. Note that in the following description, a method of producing the gas separation membrane 1 illustrated in FIG. 1 will be described as an example.

The method of producing the gas separation membrane 1 illustrated in FIG. 2 includes a first resin layer forming step S102, a second resin layer forming step S104, an activating step S105, a joining step S106, and a sacrificial layer removing step S108. Each step will be described below in sequence.

2.1. First Resin Layer Forming Step

In the first resin layer forming step S102, a film of an organopolysiloxane is formed at the first surface 21 (surface on one side) of the porous layer 2. As a result, as illustrated in FIG. 3, the first resin layer 3 is formed at the first surface 21.

Examples of the method of forming a film of an organopolysiloxane include the sol-gel method, a coating method, a plasma CVD method, and a plasma polymerization method. Among these examples, a plasma polymerization method may be used. With the plasma polymerization method, the organopolysiloxane can be deposited while the porous layer 2 is being cleaned and activated. As a result, the first resin layer 3 formed is more firmly adhered to the first surface 21. In addition, since the plasma polymerization method is a type of vapor-phase film-forming method, some of the deposited molecules adhere to the inner walls of the pores 23 of the porous layer 2. This can further increase the adhesion to the first resin layer 3. Furthermore, since the film formed using the plasma polymerization method (plasma-polymerized film) is densified, the resulting first resin layer 3 fixes the second resin layer 4 more firmly to the porous layer 2.

Examples of a raw material gas used in the plasma polymerization method include organosiloxanes such as methylsiloxane, octamethyltrisiloxane, decamethyltetrasiloxane, decamethylcyclopentasiloxane, octamethylcyclotetrasiloxane, and methylphenylsiloxane.

The pressure in a chamber used for the plasma polymerization method may be approximately from 133.3×10⁻⁵ to 1333 Pa (from 1×10⁻⁵ to 10 Torr).

The temperature of the porous layer 2 subjected to the plasma polymerization method may be approximately from 25° C. to 100° C., and the duration of film formation may be approximately from one minute to 10 minutes.

Meanwhile, the coating method uses, for example, a resin solution obtained by mixing the organopolysiloxane that has not been subjected to a curing reaction and a solvent. The resin solution is applied to the first surface 21 of the porous layer 2 and then cured. This forms the first resin layer 3 at the first surface 21.

As such, a laminate 71 of the porous layer 2 and the first resin layer 3 illustrated in FIG. 3 is obtained.

Note that since the porous layer 2 is a porous substance, the first resin layer 3 formed at the first surface 21 inherits the property and also becomes porous. As such, the first resin layer 3 functions as an intermediate layer interposed between the second resin layer 4 and the porous layer 2 without inhibiting the good gas permeability of the porous layer 2.

2.2. Second Resin Layer Forming Step

In the second resin layer forming step S104, a film of an organopolysiloxane is formed at a film formation surface 61 (surface on one side) of a sacrificial layer 6. As a result, as illustrated in FIG. 4, the second resin layer 4 is formed at the film formation surface 61.

Examples of a method of forming the film of an organopolysiloxane include the same methods as in the first resin layer forming step S102 described above. Among these examples, a plasma polymerization method may be used. Since the plasma polymerization method enables densification, the resulting second resin layer 4 has a low porosity and good selective separation properties.

As such, a laminate 72 of the sacrificial layer 6 and the second resin layer 4 illustrated in FIG. 4 is obtained.

Note that, examples of the constituent material of the sacrificial layer 6 include, for example, a material that dissolves in a solvent or the like. The sacrificial layer 6 needs to be removed in the sacrificial layer removing step S108 to be described later. Therefore, when the sacrificial layer 6 can be dissolved, the sacrificial layer 6 can be removed while deterioration or the like of the second resin layer 4 is suppressed.

Examples of the constituent material of the sacrificial layer 6 include: a water-soluble resin, such as polyvinyl alcohol, polyethylene oxide, and gelatin; and an acrylic resin. Among them, a water-soluble resin easily dissolves in an aqueous solvent, and thus is suitable as the constituent material of the sacrificial layer 6.

Note that a dense material can be used as the constituent material of the sacrificial layer 6. This allows the second resin layer 4 to have good selective separation properties even when having a small thickness. As such, the second resin layer 4 has not only good selective separation properties but also good gas permeability.

2.3. Activating Step

In the activating step S105, first, the target joining surface 31 of the first resin layer 3 is subjected to an activation treatment. Examples of the activation treatment include a method of irradiating the first resin layer 3 with energy rays, a method of heating the first resin layer 3, a method of exposing the first resin layer 3 to plasma or corona, and a method of exposing the first resin layer 3 to ozone gas. Examples of the energy rays include infrared rays, ultraviolet rays, and visible light. When the activation treatment is performed, a part of the organic groups of the organopolysiloxane constituting the first resin layer 3 is eliminated. After the elimination of the organic groups, H atoms or moisture are adsorbed to the dangling bonds, whereby active species are generated at the target joining surface 31. Examples of the active species include Si—H groups and Si—OH groups. Note that the activation treatment may be performed as needed, and may be omitted when sufficient active species are present. In addition, the target joining surface 31 can be cleaned by the activation treatment, which can contribute to further improvement in joining strength.

Similarly, a target joining surface 41 of the second resin layer 4 is also subjected to an activation treatment. As a result, active species are also generated at the target joining surface 41. This activation treatment may also be performed as needed, and may be omitted when sufficient active species are present.

2.4. Joining Step

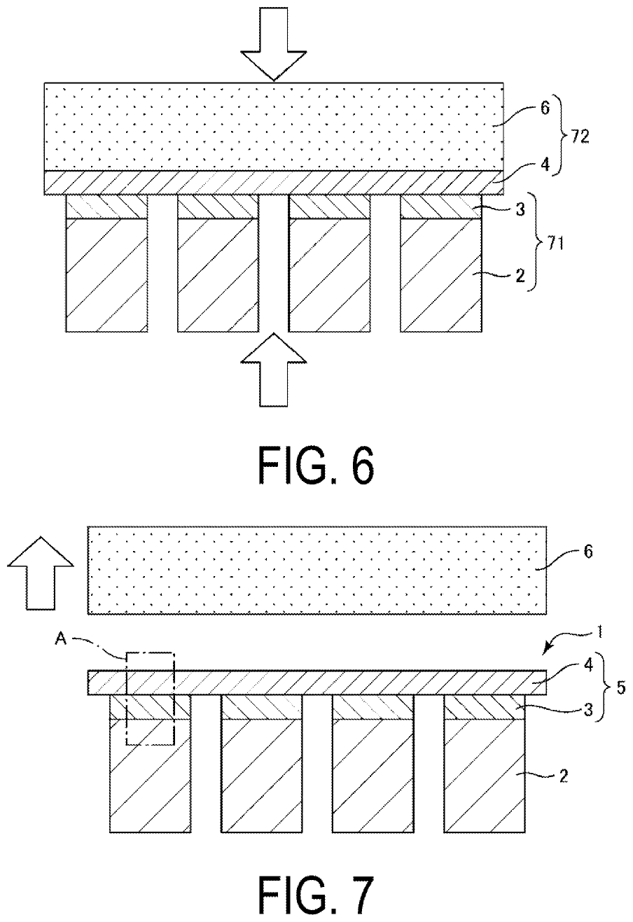

In the joining step S106, as illustrated in FIG. 5, the target joining surface 31 of the first resin layer 3 and the target joining surface 41 of the second resin layer 4 are brought into contact with each other. Then, as illustrated in FIG. 6, pressure is applied to the laminate 71 and the laminate 72 in this state. As a result, the target joining surface 31 and the target joining surface 41 are joined to each other. This joining is based on chemical bonding. Specifically, first, when the target joining surface 31 and the target joining surface 41 are brought into contact with each other, hydrogen bonds are generated between the active species such as Si—OH. Next, when pressure is applied to the laminate 71 and the laminate 72, dehydration condensation polymerization occurs between the active species. As a result, the target joining surface 31 and the target joining surface 41 are chemically joined to each other by covalent bonds. This yields the composite layer 5 of the first resin layer 3 and the second resin layer 4 illustrated in FIG. 7.

According to such a method, the first resin layer 3 and the second resin layer 4 can be integrated. Further, no inclusion exists at the joining interface. Therefore, the resulting gas separation membrane 1 has good mechanical strength, gas permeability, and selective separation properties, with uninhibited gas permeation at the joining interface.

Note that, when pressure is applied, the laminates 71 and 72 may be heated as necessary. The heating temperature, although not limited, may be approximately from 25° C. to 100° C., and may be approximately from 50° C. to 100° C. This can further increase the joining strength while suppressing denaturation of the second resin layer 4 due to heat. When necessary, the operation of applying pressure may be performed under reduced pressure. This can reduce entrainment of air bubbles. The pressure during the operation under reduced pressure is not limited, and may be any pressure less than atmospheric pressure.

Note that, the technique described in JP-A-2009-035719 can be used as the above-described joining method.

2.5. Sacrificial Layer Removing Step

In the sacrificial layer removing step S108, the sacrificial layer 6 is removed. This results in the gas separation membrane 1 illustrated in FIG. 7. The removal of the sacrificial layer 6 is performed by, for example, bringing the sacrificial layer 6 into contact with a solvent containing water, an organic solvent, or the like. In this way, the sacrificial layer 6 can be dissolved and removed. With such a method, the sacrificial layer 6 can be removed without affecting the second resin layer 4 even when the second resin layer 4 is thin. As such, it is possible to produce the gas separation membrane 1 which includes the second resin layer 4 having a low porosity while having a small thickness.

A surface having the original composition of the organopolysiloxane is exposed on the second resin layer 4 at where the sacrificial layer 6 was removed. At this surface, the affinity of the organopolysiloxane for carbon dioxide is sufficiently exhibited. As such, the gas separation membrane 1 produced by the method described above has particularly excellent selective separation properties with respect to carbon dioxide.

3. Method of Evaluating Joining Interface

As described above, in the gas separation membrane 1, the target joining surface 31 and the target joining surface 41 are chemically bonded to each other. In the process of this bonding, it is necessary to generate the aforementioned active species on the target joining surfaces 31 and 41 and to cause a polymerization reaction such as dehydration condensation polymerization. Meanwhile, since the constituent materials of the first resin layer 3 and the second resin layer 4 are each an organopolysiloxane, elimination of organic groups is necessary in order to generate active species at the target joining surfaces 31 and 41.

When the organic groups are eliminated, the concentration of the organic groups decreases in the vicinity of the target joining surfaces 31 and 41. As a result, a region where the concentration of the organic groups is relatively low is generated in the vicinity of the joining interface after joining. The presence or absence of organic groups can be identified by, for example, confirming the chemical bonding state of the Si atoms. Therefore, whether the target joining surface 31 and the target joining surface 41 are chemically bonded to each other can be evaluated based on the analysis result of the chemical bonding state of the Si atoms.

Specifically, ion sputtering is performed from the surface side of the formed composite layer 5 to remove sample in the depth direction. Repeating ion sputtering and the analysis of chemical bonding state, the latter by using X-ray photoelectron spectroscopy, yields a profile of the chemical bonding state of a predetermined element in the depth direction.

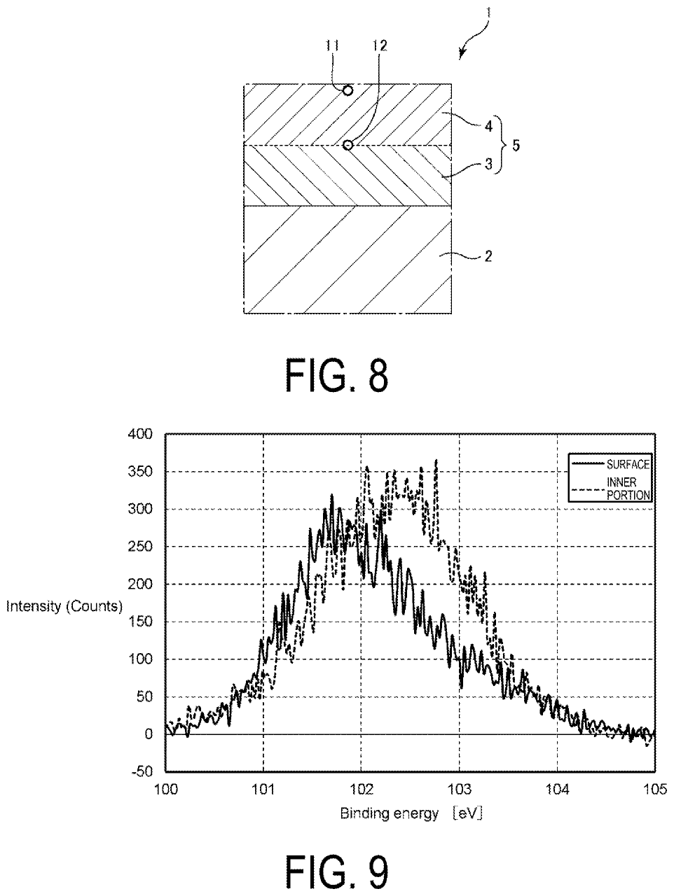

FIG. 8 is an enlarged view of an area A in FIG. 7. In FIG. 8, a surface of the composite layer 5 exposed to the mixed gas is referred to as a “surface 11”, and a position deeper than the surface 11 is referred to as an “inner portion 12”. Further, FIG. 9 are X-ray photoelectron spectroscopy spectra including a Si2p peak obtained for the surface 11 and the inner portion 12 of the composite layer 5 illustrated in FIG. 8.

The surface 11 of the composite layer 5 illustrated in FIG. 8 is originally an interface between the second resin layer 4 and the sacrificial layer 6. Therefore, the surface 11 has the original composition of the organopolysiloxane, and thus Si atoms contained in the surface 11 are considered to be bonded to organic groups at a high ratio. As such, the Si2p peak obtained for the surface 11 indicates a chemical bonding state corresponding to the Si—C bonds. In the example of FIG. 9, the energy of the Si2p peak obtained for the surface 11 is from 101 eV to 102 eV, which corresponds to the Si—C bonds.

Meanwhile, the inner portion 12 of the composite layer 5 illustrated in FIG. 8 is a region close to the joining interface between the second resin layer 4 and the first resin layer 3. Therefore, the inner portion 12 is considered to be affected by the above-described elimination of organic groups and have a low concentration of organic groups. As such, the Si2p peak obtained for the inner portion 12 indicates a chemical bonding state corresponding to the Si—O bonds. In the example of FIG. 9, the energy of the Si2p peak obtained for the inner portion 12 is from 102 eV to 103 eV, which corresponds to the Si—O bonds. It should be noted that the inner portion 12 refers to a portion 10 nm or deeper from the surface 11.

Based on the above, the surface 11 of the composite layer 5 has a higher ratio of Si—C bonds than the inner portion 12 has, and the inner portion 12 has a higher ratio of Si—O bonds than the surface 11 has. That is, compared to the inner portion 12, the surface 11 is considered to have a higher ratio of M units than T units per molecule of the organopolysiloxane; in contract, compared to the surface 11, the inner portion 12 is considered to have a higher ratio of T units than M units per molecule of the organopolysiloxane. Based on the analysis result, it can be identified that the target joining surface 31 and the target joining surface 41 are chemically bonded to each other.

4. Use of Gas Separation Membrane

The gas separation membrane 1 according to an embodiment can be used for gas separation and recovery, gas separation and purification, and the like. For example, the gas separation membrane 1 is used to efficiently separate a specific gas component from a mixed gas containing gas components such as hydrogen, helium, carbon monoxide, carbon dioxide, hydrogen sulfide, oxygen, nitrogen, ammonia, sulfur oxides, nitrogen oxides, as well as saturated hydrocarbons such as methane, ethane, unsaturated hydrocarbons such as propylene, and perfluorohydrocarbons such as tetrafluoroethane. In particular, the gas separation membrane 1 may be used for the purpose of selectively allowing the passage of carbon dioxide from a mixed gas containing carbon dioxide and other gas components. Thus, the gas separation membrane 1 can be applied to, for example, a technique for separating and recovering carbon dioxide contained in the atmosphere (direct air capture, or DAC) and a technique for separating and recovering carbon dioxide from a crude oil-associated gas or a natural gas containing methane as the main component.

5. Effects Achieved by Embodiment Described Above

As described above, the gas separation membrane 1 according to the embodiment described above includes the porous layer 2, the first resin layer 3, and the second resin layer 4. The first resin layer 3 is provided at the first surface 21 (surface on one side) of the porous layer 2 and contains an organopolysiloxane. The second resin layer 4 is provided at the target joining surface 31 (surface on a side opposite to that of the porous layer 2) of the first resin layer 3 and contains an organopolysiloxane. The first resin layer 3 has a porosity greater than that of the second resin layer 4. Further, the second resin layer 4 is chemically bonded to the first resin layer 3.

With such a configuration, the second resin layer 4 is chemically bonded to the first resin layer 3, and as such the adhesion is improved even when the second resin layer 4 has a small thickness. That is, there is no need to consider increasing adhesion by increasing the thickness of the second resin layer 4, which allows the second resin layer 4 to have a sufficiently small film thickness. In addition, the first resin layer 3 has a high porosity, and thus gas permeability is less likely to be inhibited. As such, the gas permeability of the gas separation membrane 1 can be sufficiently increased. In addition, since the composite layer 5 has high mechanical strength, the gas separation membrane 1 is less likely to be damaged even when used while bent or folded, for example.

The sum of the average thickness of the first resin layer 3 and the average thickness of the second resin layer 4 may be from 50 nm to 500 nm. This allows the composite layer 5 of the first resin layer 3 and the second resin layer 4 to have both good adhesion to the porous layer 2 and good gas permeability.

The constituent material of the porous layer 2 may be a ceramic material. This can further increase the adhesion between the porous layer 2 and the first resin layer 3.

The method of producing the gas separation membrane according to the embodiment described above includes the first resin layer forming step S102, the second resin layer forming step S104, the joining step S106, and the sacrificial layer removing step S108. In the first resin layer forming step S102, a film of an organopolysiloxane is formed at the first surface 21 (surface on one side) of the porous layer 2, resulting in the first resin layer 3. In the second resin layer forming step S104, a film of an organopolysiloxane is formed at a film formation surface 61 (surface on one side) of the sacrificial layer 6, resulting in the second resin layer 4. In the joining step S106, the first resin layer 3 and the second resin layer 4 are brought into contact with each other and subjected to pressure-joining. In the sacrificial layer removing step S108, the sacrificial layer 6 is removed.

According to such a method of producing a gas separation membrane, the first resin layer 3 and the second resin layer 4 can be chemically bonded to each other, and the adhesion can be increased even when the second resin layer 4 has a small thickness. This makes it possible to sufficiently increase the mechanical strength and the gas permeability of the composite layer 5 of the first resin layer 3 and the second resin layer 4. In addition, by including the sacrificial layer removing step S108, the second resin layer 4 having a low porosity while having a small thickness can be formed. The resulting second resin layer 4 is excellent in both selective separation properties and gas permeability. Furthermore, since no inclusion exists in chemical bonding, gas permeability is less likely to be reduced due to inclusion.

The method of producing the gas separation membrane according to the embodiment described above may include the activating step S106 provided before the joining step S105. In the activating step S105, the first resin layer 3 and the second resin layer 4 are subjected to an activation treatment to activate the target joining surfaces 31 and 41. Then, in the joining step S106, the target joining surfaces 31 and 41 are brought into contact with each other and subjected to pressure-joining.

According to such a method of producing a gas separation membrane, the target joining surfaces 31 and 41 can be cleaned, which can contribute to further improvement in joining strength.

In the first resin layer forming step S102, the first resin layer 3 may be formed by a plasma polymerization method. In the second resin layer forming step S104, the second resin layer 4 may be formed by a plasma polymerization method.

With the plasma polymerization method, an organopolysiloxane can be deposited while the porous layer 2 or the film formation surface of the sacrificial layer 6 is being cleaned and activated. As such, the first resin layer 3 and the second resin layer 4 formed are more firmly adhered to the porous layer 2 and the sacrificial layer 6. In addition, according to the plasma polymerization method, the first resin layer 3 and the second resin layer 4 can be densified. As a result, the first resin layer 3 can firmly fix the second resin layer 4, and the second resin layer 4 has good selective separation properties even when having a small thickness.

Although the gas separation membrane and the method of producing a gas separation membrane according to an aspect of the present disclosure have been described above based on a preferred embodiment, the present disclosure is not limited thereto.

For example, in the gas separation membrane according to an aspect of the present disclosure, each part of the embodiment described above may be replaced with a component having a similar function, and any component may be added to the embodiment described above. In addition, the method of producing the gas separation membrane according to an aspect of the present disclosure may be the embodiment described above plus an additional step having a purpose.

### Examples

Next, specific examples of the present disclosure will be described.

6. Preparation of Gas Separation Membrane

6.1. Example 1

First, a film of an organopolysiloxane was formed at a surface on one side of a porous layer made of alumina by a plasma polymerization method. This resulted in a first resin layer having an average thickness of 30 nm. Note that octamethyltrisiloxane was used as the raw material gas. The porous layer had a thickness of 60 μm and a porosity of 50%.

Next, a film of an organopolysiloxane was formed at a surface on one side of a water-soluble film serving as a sacrificial layer by plasma polymerization. This resulted in a second resin layer having an average thickness of 30 nm. Note that octamethyltrisiloxane was used as the raw material gas.

Next, the first resin layer and the second resin layer were each subjected to an activation treatment by irradiation with ultraviolet rays. Subsequently, the first resin layer and the second resin layer were placed in an overlapping position while being in contact with each other, and pressure was applied while heating was performed. As a result, the first resin layer and the second resin layer were joined to each other, resulting in a gas separation membrane. A cross-sectional observation confirmed that the porosity of the first resin layer was higher than that of the second resin layer.

6.2. Examples 2 to 4

Gas separation membranes were obtained in the same manner as in Example 1 except that the compositions of the gas separation membranes were changed to those presented in Table 1.

6.3. Example 5

A gas separation membrane was obtained in the same manner as in Example 1 except that the method of forming the first resin layer was changed to a coating method and that the composition of the gas separation membrane was changed to what was presented in Table 1. Note that, the coating liquid used in the coating method was the same as the silicone solution used in the preparation of the gas separation membrane of Comparative Example described below.

6.4. Comparative Example

First, a silicone solution was applied to a surface on one side of a porous layer made of alumina. The silicone solution used was prepared by dissolving a silicone rubber containing a phenyl group in toluene and adding a vulcanizing agent. Primary vulcanization of the porous layer coated with the silicone solution was performed by heating at 170° C. for 10 minutes. Then, secondary vulcanization was performed by heating at 200° C. for four hours. This resulted in a siloxane compound thin film (first resin layer) having a thickness of 25 μm.

Next, the resulting siloxane compound thin film was placed in a plasma device, and the pressure inside the device was reduced to 0.13 Pa (0.001 Torr). Then, argon gas was supplied to the inside of the device. Next, while the pressure inside the device was maintained at 40 Pa, a plasma treatment was performed at a power of 100 W for five minutes. Subsequently, the pressure inside the device in which the plasma treatment was performed was reduced again to 0.13 Pa, resulting in a plasma-polymerized layer (second resin layer) having a thickness of 260 nm. Methyltrivinylsilane was used as the raw material gas. In this way, a gas separation membrane including the porous layer, the siloxane compound thin film, and the plasma-polymerized layer was obtained.

7. Evaluation of Gas Separation Membrane

The gas separation membranes of Examples and Comparative Example were evaluated as follows.

7.1. Gas Permeability and Selective Separation Properties

The gas separation membranes of Examples and Comparative Example were cut into circles having a diameter of 5 cm, resulting in test samples. Next, a mixed gas in which carbon dioxide and nitrogen were mixed at a volume ratio of 13:87 was supplied upstream of the test samples using a gas transmission rate measuring device. Note that, the total pressure upstream was adjusted to 5 MPa, the partial pressure of carbon dioxide was adjusted to 0.65 MPa, the flow rate was adjusted to 500 mL/min, and the temperature was adjusted to 40° C. Then, gas components passed through the test samples were analyzed by gas chromatography.

Next, based on the analytical results, the carbon dioxide gas permeation rates R_{CO2} and the nitrogen gas permeation rates R_{N2} at the gas separation membranes were calculated. Then, relative evaluation of the gas permeabilities of the gas separation membranes was performed by comparing the carbon dioxide gas permeation rates R_{CO2} with the following evaluation criteria.
A: The carbon dioxide gas permeation rate R_{CO2} is greater than that in Comparative Example
B: The carbon dioxide gas permeation rate R_{CO2} is equivalent to that in Comparative Example
C: The carbon dioxide gas permeation rate R_{CO2} is less than that in Comparative Example

The evaluation results are presented in Table 1.

In addition, the ratio of the carbon dioxide gas permeation rate R_{CO2} to the nitrogen gas permeation rate R_{N2}, or R_{CO2}/R_{N2}, was calculated. Then, relative evaluation of the selective separation properties of the gas separation membranes was performed by comparing the ratio R_{CO2}/R_{N2} with the following evaluation criteria.
A: The ratio R_{CO2}/R_{N2} is greater than that in Comparative Example
B: The ratio R_{CO2}/R_{N2} is equivalent to that in Comparative Example
C: The ratio R_{CO2}/R_{N2} is less than that in Comparative Example

The evaluation results are presented in Table 1.

7.2. Mechanical Strength

The gas separation membranes of Examples and Comparative Example were folded in a concertina shape and then smoothed out. After the operation was repeated 10 times, the gas separation membranes were cut into circles having a diameter of 5 cm, resulting in test samples.

Next, the ratio R_{CO2}/R_{N2} was calculated for the test samples by the same method as in 7.1. Then, based on the ratio R_{CO2}/R_{N2} before the bending test and the ratio R_{CO2}/R_{N2} after the bending test, the decrease in the ratio R_{CO2}/R_{N2} was calculated. The decrease in the ratio R_{CO2}/R_{N2} is an indicator that quantitatively indicates the degree to which the selective separation properties deteriorated during the bending test. Relative evaluation of the mechanical strengths (bending resistances) of the gas separation membranes was performed by comparing the decrease in the ratio R_{CO2}/R_{N2} calculated with the following evaluation criteria.
A: The decrease in the ratio R_{CO2}/R_{N2} is less than that in Comparative Example
B: The decrease in the ratio R_{CO2}/R_{N2} is equivalent to that in Comparative Example
C: The decrease in the ratio R_{CO2}/R_{N2} is greater than that in Comparative Example

The evaluation results are presented in Table 1.

TABLE 1

| | | | Example | Example | Example | Example | Example | Comparative |
|---|---|---|---|---|---|---|---|---|
| | | | 1 | 2 | 3 | 4 | 5 | Example |
| Composition | Porous | Constituent | Alumina | | | | | Alumina |
| of gas | layer | material | | | | | | |
| separation | First | Forming | Plasma polymerization method | | | | Coating | Coating method |
| membrane | resin | method | | | | | method | |
| | layer | Constituent | Organopolysiloxane | | | | | Organopolysiloxane |
| | | material | | | | | | |
| | | Average | 30 nm | 50 nm | 100 nm | 100 nm | 1000 nm | 25 μm |
| | | thickness | | | | | | |
| | Second | Forming | Plasma polymerization method | | | | | Plasma |
| | resin | method | | | | | | polymerization |
| | layer | | | | | | | method |
| | | Constituent | Organopolysiloxane | | | | | Organopolysiloxane |
| | | material | | | | | | |
| | | Average | 30 nm | 100 nm | 200 nm | 500 nm | 150 nm | 260 nm |
| | | thickness | | | | | | |

| | Method of joining | Chemical bonding | | | | | Physical bonding |
|---|---|---|---|---|---|---|---|
| | first resin layer | | | | | | |
| | and second resin | | | | | | |
| | layer | | | | | | |
| Evaluation | Gas permeability | A | A | A | B | A | — |
| result of | Selective | B | B | B | B | B | — |
| gas | separation | | | | | | |
| separation | properties | | | | | | |
| membrane | Mechanical | A | A | A | A | B | — |
| | strength | | | | | | |

As is clear from Table 1, the gas separation membranes of Examples had better gas permeability with respect to carbon dioxide than that of the gas separation membrane of Comparative Example. This result is considered to be attributable to the small thickness of the second resin layers responsible for gas separation in the gas separation membranes of Examples.

In addition, compared to the gas separation membrane of Comparative Example, the gas separation membranes of Examples were able to have a smaller decrease in the ratio R_{CO2}/R_{N2} before and after the bending test. This result is considered to be attributable to the fact that the gas separation membranes of Examples had excellent bending resistance due to their high mechanical strength. In the gas separation membranes of Examples, the first resin layers and the second resin layers were joined to each other by chemical bonding. In comparison, in the gas separation membrane of Comparative Example, the siloxane compound thin film (first resin layer) and the plasma-polymerized layer (second resin layer) were joined to each other by physical bonding. Therefore, the difference in joining mechanisms is considered to be reflected in the bending resistance.

What is claimed is:

1. A gas separation membrane comprising:
a porous layer;
a first resin layer provided at a surface on one side of the porous layer, the first resin layer including an organopolysiloxane; and
a second resin layer provided at a surface of the first resin layer on a side opposite to that of the porous layer, the second resin layer including an organopolysiloxane, wherein
the first resin layer has a porosity greater than that of the second resin layer and
the second resin layer is chemically bonded to the first resin layer.

2. The gas separation membrane according to claim 1, wherein
a sum of an average thickness of the first resin layer and an average thickness of the second resin layer is from 50 nm to 500 nm.

3. The gas separation membrane according to claim 1, wherein
a constituent material of the porous layer is a ceramic material.

4. A method of producing a gas separation membrane, the method comprising:
a first resin layer forming step of forming a film of an organopolysiloxane at a surface on one side of a porous layer to form a first resin layer;
a second resin layer forming step of forming a film of an organopolysiloxane at a surface on one side of a sacrificial layer to form a second resin layer;
a joining step of bringing the first resin layer and the second resin layer into contact with each other and subjecting the first resin layer and the second resin layer to pressure-joining; and
a sacrificial layer removing step of removing the sacrificial layer.

5. The method of producing a gas separation membrane according to claim 4, the method further comprising
an activating step of subjecting the first resin layer and the second resin layer to an activation treatment to activate target joining surfaces, the activating step being provided before the joining step, wherein
in the joining step, the target joining surfaces are brought into contact with each other and subjected to pressure-joining.

6. The method of producing a gas separation membrane according to claim 4, wherein
in the first resin layer forming step, the first resin layer is formed by a plasma polymerization method and
in the second resin layer forming step, the second resin layer is formed by a plasma polymerization method.
